(19) United States
(12) Patent Application Publication
(10) Pub. No.: US 2016/0098242 A1
(43) Pub. Date: Apr. 7, 2016

(54) MOTHERBOARD FOR A COMPUTER SYSTEM AND A COMPUTER SYSTEM

(71) Applicant: FUJITSU TECHNOLOGY SOLUTIONS INTELLECTUAL PROPERTY GMBH, München (DE)

(72) Inventors: Waldemar Felde, Augsburg (DE); Rainer Staude, Fischach (DE)

(21) Appl. No.: 14/782,071

(22) PCT Filed: Apr. 24, 2014
(86) PCT No.: PCT/EP2014/058384

§ 371 Date: Oct. 2, 2015

(30) Foreign Application Priority Data
Jun. 26, 2013 (DE) 10 2013 106 697.6

(51) Int. Cl. G06F 3/16; H04R 1/02; H04R 3/00

(52) U.S. Cl. CPC G06F 3/162; H04R 3/00; H04R 1/028

(57) ABSTRACT

A motherboard for a computer system that electrically connected to an acoustic transmitter that outputs acoustic signals includes a first sound generator circuit configured to generate a first control signal for the acoustic transmitter; a second sound generator circuit configured to generate a second control signal for the acoustic transmitter; and a logic circuit electrically coupled to the first sound generator circuit via a first signal line and to the second sound generator circuit via a second signal line and configured to transfer the first control signal or the second control signal to the acoustic transmitter.

### TECHNICAL FIELD

This disclosure relates to a motherboard for a computer system, in particular for a desktop PC. The motherboard electrically connects to an acoustic transmitter to output acoustic signals. The disclosure further relates to a computer system.

### BACKGROUND

Motherboards having such an acoustic transmitter, in particular having a piezo sound converter, are known. Such an acoustic transmitter, which can also be referred to as a system loudspeaker, sounder, buzzer or beeper, is generally fixedly soldered to the motherboard. The acoustic transmitter allows software and/or firmware such as BIOS (Basic Input Output System) to output an audible feedback signal for a user to signal, for example, a hardware fault and/or the start of a boot-up process of the PC system. Generally, the acoustic transmitter is the first output device activated during the boot-up process. Generally, the acoustic transmitter can only reproduce rectangular waves, wherein only two states—on and off—can be activated. The two states correspond to two positions of a membrane of the acoustic transmitter. The acoustic transmitter can be switched on and off by a predetermined control signal at a predetermined switching frequency, wherein it generates an acoustic or beeping signal of a particular acoustic frequency until it is deactivated. Generally, only a few different acoustic or beeping patterns (e.g., long-short-long) can be signalled depending on the switching frequency. These acoustic patterns are specific to the motherboard and cannot essentially readily be influenced.

There is a need, however, to provide a motherboard for a computer system having an acoustic transmitter which allows acoustic and/or beeping patterns to be output in a customized manner independent of the manufacturer.

### SUMMARY

We provide a motherboard for a computer system electrically connected to an acoustic transmitter that outputs acoustic signals comprising: a first sound generator circuit configured to generate a first control signal for the acoustic transmitter; a second sound generator circuit configured to generate a second control signal for the acoustic transmitter; and a logic circuit electrically coupled to the first sound generator circuit via a first signal line and to the second sound generator circuit via a second signal line and configured to transfer the first control signal or the second control signal to the acoustic transmitter.

We also provide a computer system comprising the motherboard.

### BRIEF DESCRIPTION OF THE DRAWING

FIG. 1 shows a schematic illustration of a section of a motherboard.

### LIST OF REFERENCE SIGNS

AKS General contact pin
IC Integrated circuit
HP Motherboard
LS Logic circuit
SL1 Signal line
SL2 Signal line
TES1 First sound generator circuit
TES2 Second sound generator circuit
TG Acoustic transmitter
VCC Terminal

### DETAILED DESCRIPTION

We provide a motherboard for a computer system, in particular for a desktop PC, and electrically connects to an acoustic transmitter, in particular a piezo-sound converter, to output acoustic signals. The motherboard comprises a first sound generator circuit configured to generate a first control signal for the acoustic transmitter. The motherboard further comprises a second sound generator circuit configured to generate a second control signal for the acoustic transmitter. The motherboard further comprises a logic circuit electrically coupled to the first sound generator circuit via a first signal line and to the second sound generator circuit via a second signal line and is configured to transfer the first control signal or the second control signal to the acoustic transmitter.

The acoustic transmitter can also be called a tone generator. A sound generator circuit can also be referred as a tone generator circuit or sound production circuit.

The motherboard ensures that the acoustic transmitter which, for example, is a beeper, sounder, buzzer or system loudspeaker, can be addressed not only by the first sound generator circuit but also by the second sound generator circuit. The first sound generator circuit corresponds to a circuit to be found as standard on a circuit board to activate the acoustic transmitter. The first sound generator circuit is a “rigid circuit” which is also provided by the chip set or in accordance with the general PC design exclusively to output or generate the control signals of the manufacturer-specific acoustic patterns described in the introduction, which can also be referred to as beeping alarm signals. If it were desired to output other acoustic patterns or signal tones then corresponding software would have to obtain access to an interface of the first sound generator circuit and to modulate the first control signal of the tones to be output in a complicated manner. This requires additional computing capacity at least of one processor.

In addition, a second sound generator circuit is arranged on the motherboard and can generate a second control signal substantially different from the first control signal, to output acoustic signals using the acoustic transmitter. It is thus possible to extend and/or vary the acoustic pattern predetermined by the manufacturer. Either the first control signal or the second control signal is transferred to the acoustic transmitter by the logic circuit. The second sound generator circuit can be activated in a simple and energy-saving manner, wherein the second sound generator circuit itself generates the corresponding second control signal.

Advantageously, the first sound generator circuit cannot be activated in an energy-saving mode of an operating system and the second sound generator circuit can be activated in the energy-saving mode. The energy-saving mode can correspond to the ACPI standard (Advanced Configuration and Power Interface) for energy management.

In accordance with the ACPI standard, the monitoring of which regarding energy management is generally completely within the operating system, the computer system can assume different rest or standby states (e.g., S1, S2, S3 or S4), wherein the degree of energy savings is characterized by the increasing numbering of the states. For example, the S3 mode corresponds to the standby mode (Suspend to Ram) in which, for example, most of the hardware of the motherboard is switched off and the operating state is saved in a volatile memory. In accordance with the S4 state, the computer is placed into a rest state (Suspend to Disk) in which the operating state of the system is saved in a non-volatile memory. Such rest states are useful in particular when the computer system is essentially not being used and energy is to be saved.

The energy-saving state in accordance with the ACPI standard provides precise specifications as to which components, elements or component assemblies of the computer system are operative and which are not. If user-specific and/or additional (power-saving) properties of an energy-saving state are now to be implemented, then an additional energy-saving state outside of the ACPI standard is required. Generally, in states S3 and S4, the first and second sound generator circuits and further components such as, for example, the acoustic transmitter or a chip set are switched off and/or are in a sleep state. That is to say that, for example, the first sound generator circuit is not powered. If the chip set is in such a sleep state, then the chip set cannot readily implement functions and/or actions since, for example, no software is active to evaluate events (in the background). Therefore, a control signal for the acoustic transmitter to output acoustic signals cannot be generated via the first sound generator circuit and/or the second sound generator circuit. If the computer system does not have an additionally connected speaker or loudspeaker, then system sounds and/or other sounds cannot be output.

However, if particular events are nevertheless to be acoustically signalled to the user, in particular in an additional energy-saving state (outside of the ACPI specification), then the second sound generator circuit intervenes, which circuit is or can be activated in the additional energy-saving mode. Events can be, for example, the arrival of e-mails (e.g., via an e-mail client such as Microsoft's Outlook), Voice-over-IP calls (VoIP) or the like. It is thus possible to acoustically signal to a user when such an event has occurred, despite being in energy-saving mode.

Advantageously, the logic circuit may comprise a logic gate, in particular an OR gate. It is thus possible to simply transfer either the first control signal of the first sound generator circuit and/or the second control signal of the second sound generator circuit to the acoustic transmitter.

Advantageously, the logic circuit may comprise at least two transistors having an open collector output. A simple manner of achieving a logic circuit by discrete switching elements is thus presented. In addition, a cost-favorable example of the logic circuit is thus presented.

Further advantageously, the second sound generator circuit can be activated via a signal of a general contact pin of an integrated circuit of the motherboard, in particular a GPIO pin. The behavior of the so-called GPIO pin can be freely determined by logical programming, irrespective of whether it is provided as an input contact or output contact. Generally, GPIO pins do not have a specified purpose which means that they are idle as standard. Therefore, the second sound generator circuit can be activated in a simple manner, e.g., in the energy-saving mode, wherein only the general contact pin or GPIO pin has to be digitally reversed. The second control signal is generated by the second sound generator circuit itself and does not require any additional software intervention, for example.

Advantageously, the first sound generator circuit may be an audio controller. Audio controllers are provided on a motherboard as standard to actuate the acoustic transmitter, for example. Such an audio controller is generally switched off in an energy-saving mode such as, for example, the S3 state.

Further advantageously, the second sound generator circuit may comprise at least one multivibrator. A multivibrator, also known as an astable multivibrator, is an electronic circuit for switching between two states. Such a multivibrator is used as a signal generator to generate rectangular waves or as a sound generator for piezoelectric transducers.

We also provide a computer system which comprises our motherboard.

The computer system essentially comprises the afore-mentioned advantages.

Further advantages are disclosed in the following detailed description of an example.

An example is described hereinafter with the aid of the appended FIGURE.

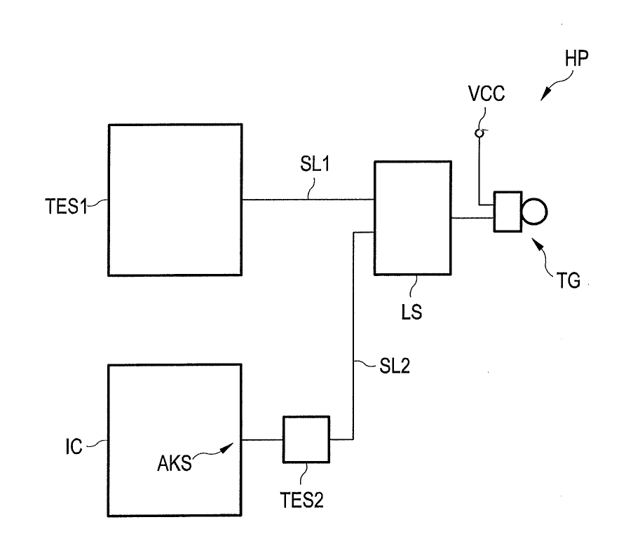

FIG. 1 shows a schematic illustration of a section of a motherboard HP for a computer system, in particular for a desktop PC. In FIG. 1, only the relevant components of the motherboard HP are illustrated. Further components have been omitted in the illustration for improved clarity.

The motherboard HP comprises a first sound generator circuit TES1 electrically connected to a logic circuit LS via a first signal line SL1. The motherboard HP further comprises a second sound generator circuit TES2 electrically connected to the logic circuit LS by a second signal line SL2. The second sound generator circuit TES2 electrically connects to a general contact pin AKS of an integrated circuit IC of the motherboard HP. The logic circuit LS electrically connects to an acoustic transmitter TG supplied with voltage via a terminal VCC. The acoustic transmitter TG is generally soldered to the motherboard HP. Alternatively, the acoustic transmitter TG can also be electrically connected to the motherboard HP, for example, via a cable.

The first sound generator circuit TES1 and the acoustic transmitter TG are components of the standard motherboard HP. The acoustic transmitter TG is, for example, a buzzer, beeper, sounder or system loudspeaker formed as a piezo-sound converter. The first sound generator circuit TES1 is, for example, an audio controller which can be addressed using an operating system. As described in the introduction, the acoustic transmitter TG is configured to generate a predetermined number of acoustic or beeping patterns to signal, for example, system sounds, error codes or the like. The acoustic transmitter TG is controlled by the first sound generator circuit TES1 which generates a first control signal. The first sound generator circuit TES1 is a “rigid circuit” as described in the introduction, which is generally provided exclusively to output the predetermined acoustic pattern.

If the computer system is placed, as described in the introduction, into an additional energy-saving state outside of the ACPI specification, then generally most of the hardware of the motherboard HP is switched off, inter alia also the first sound generator circuit TES1 or the audio controller. Therefore, the acoustic transmitter TG can no longer be activated via the first sound generator circuit TES1. If the computer system does not comprise loudspeakers or speakers, connected to the motherboard HP or to the computer system, then it is not possible to signal particular events to a user. Such events can be, for example, the arrival of an e-mail, an incoming Voice-over-IP call (VoIP) or the like, wherein the presence of an active network connection is presupposed in the energy-saving mode. Signalling an event in this manner may be necessary, for example, when a user does not wish to use the computer system and wants to save energy. However, the user remains in proximity to this computer system and nevertheless possibly wishes incoming e-mails or calls to be signalled.

To signal such events, the second sound generator circuit TES2 is now provided, which can also be referred to as a sound or message generator and can be activated in particular in the additional energy-saving state. The second sound generator circuit TES2 can be addressed and/or activated, for example, via the general contact pin AKS of the integrated circuit IC of the motherboard HP. Such a general contact pin AKS or GPIO pin is idle as standard and does not have a specified purpose. The general contact pin AKS can be programmed such that the second sound generator circuit TES2 can be addressed when a corresponding event occurs to generate a second control signal for the acoustic transmitter TG. For example, the second sound generator circuit TES2 receives a binary signal via the general contact pin AKS, which signal can be, for example, a logical “1” or a logical “0”. For example, if the second sound generator circuit TES2 receives a logical “1”, it is activated. In particular, the second sound generator circuit TES2 can thus be activated by the general contact pin AKS or GPIO pin in the additional energy-saving mode. The second sound generator circuit TES2 simply permits, in an energy-saving manner, generation of the second control signal, wherein only the general contact pin AKS has to be reversed. The second control signal is generated completely by the second sound generator circuit TES2 and requires no additional software, for example.

It should be noted that the second sound generator circuit TES2 does not necessarily have to be activated in an energy-saving state. Rather, the second sound generator circuit TES2 can also be activated in a normal operating mode of the computer system if, for example, the first sound generator circuit TES1 is likewise operable and activatable. This can be useful if, for example, additional acoustic patterns are to be output by the acoustic transmitter TG to acoustically signal particular events different from the manufacturer-specific events.

The second sound generator circuit TES2 connects to the logic circuit LS via the second signal line S2 which is configured to transmit the first control signal of the first sound generator circuit TES1 and/or the second control signal of the second sound generator circuit TES2 to the acoustic transmitter TG. The logic circuit LS can comprise, for example, logic gates such as an OR gate. For example, the logic circuit LS can comprise at least two transistors having an open collector output.

The second sound generator circuit TES2 is activated or deactivated by an enable signal using the general contact pin AKS and autonomously produces the second control signal in the corresponding sound frequency or sequence. The enable signal is activated autonomously by the operating system after the corresponding event has been recognized.

The second sound generator circuit can be activated alternatively via an evaluation of network accesses (LAN accesses) by so-called “magic packets”. Direct access is effected from the network to a LAN controller with a particular MAC address. This would enable the first sound generator circuit TES1 and/or the second sound generator circuit TES2 to also be activated, for example, in an S3 or S4 state.

The second sound generator circuit TES2 can comprise at least one multivibrator, as described in the introduction, to generate the first control signal. The second sound generator circuit TES2 substantially consists of a known cascading arrangement of several circuits, to generate a second control signal for the acoustic transmitter TG.

The second sound generator circuit TES2 can generate different beeping or acoustic patterns which are transmitted to the acoustic transmitter TG via the logic circuit LS in the form of the second control signal for it to be possible to generate a corresponding acoustic signal by the acoustic transmitter TG. Generally, the second sound generator circuit generates rectangular-wave signals, the pulses of which are varied by pulse-width modulation. Therefore, the most varied control signals can be generated for the acoustic transmitter TG. For example, buzzing or ringing of a telephone can be perceived when a VoIP event (a call) is recognized in the energy-saving mode of the computer system and is to be signalled to the user. Therefore, individual acoustic or beeping patterns can be output and acoustically signalled to the user.

With the second sound generator circuit TES2, not only provided acoustic patterns, which are implemented by the manufacturer in the motherboard HP, can be extended but also the acoustic transmitter TG can be activated in an energy-saving mode, wherein the first sound generator circuit TES1 is deactivated. Therefore, a user can be informed of particular events while the computer system is in an energy-saving mode and draws little power. The acoustic transmitter TG, in parallel with its main function, that is to say the actuation by the first sound generator circuit TES1, can therefore also be actuated by the second sound generator circuit TES2.

1-9. (canceled)

10. A motherboard for a computer system electrically connected to an acoustic transmitter that outputs acoustic signals comprising:
a) a first sound generator circuit configured to generate a first control signal for the acoustic transmitter;
b) a second sound generator circuit configured to generate a second control signal for the acoustic transmitter; and
c) a logic circuit electrically coupled to the first sound generator circuit via a first signal line and to the second sound generator circuit via a second signal line and configured to transfer the first control signal or the second control signal to the acoustic transmitter.

11. The motherboard according to claim 10, wherein the first sound generator circuit cannot be activated in an energy-saving mode of an operating system and the second sound generator circuit is activated in the energy-saving mode.

12. The motherboard according to claim 10, wherein the logic circuit comprises a logic gate.

13. The motherboard according to claim 10, wherein the logic circuit comprises at least two transistors having an open collector output.

14. The motherboard according to claim 10, wherein the second sound generator circuit can be activated via a signal of a general contact pin of an integrated circuit of the motherboard.

15. The motherboard according to claim 10, wherein the first sound generator circuit is an audio controller.

16. The motherboard according to claim 10, wherein the second sound generator circuit comprises at least one multivibrator.

17. The motherboard according to claim 10, wherein the motherboard comprises the acoustic transmitter and the acoustic transmitter is a buzzer, beeper, sounder or system loudspeaker.

18. A computer system comprising the motherboard according to claim 10.

19. The motherboard according to claim 11, wherein the logic circuit comprises a logic gate.

20. The motherboard according to claim 11, wherein the logic circuit comprises at least two transistors having an open collector output.

21. The motherboard according to claim 12, wherein the logic circuit comprises at least two transistors having an open collector output.

22. The motherboard according to claim 11, wherein the second sound generator circuit can be activated via a signal of a general contact pin of an integrated circuit of the motherboard.

23. The motherboard according to claim 12, wherein the second sound generator circuit can be activated via a signal of a general contact pin of an integrated circuit of the motherboard.

24. The motherboard according to claim 13, wherein the second sound generator circuit can be activated via a signal of a general contact pin of an integrated circuit of the motherboard.

25. The motherboard according to claim 11, wherein the first sound generator circuit is an audio controller.

26. The motherboard according to claim 12, wherein the first sound generator circuit is an audio controller.

27. The motherboard according to claim 13, wherein the first sound generator circuit is an audio controller.

28. The motherboard according to claim 14, wherein the first sound generator circuit is an audio controller.
